(19) United States
(12) Patent Application Publication
(10) Pub. No.: US 2009/0310071 A1
(43) Pub. Date: Dec. 17, 2009

(54) TRANSREFLECTIVE DISPLAY PANEL AND DISPLAY APPARATUS INCLUDING THE SAME

(76) Inventors: Seongmo HWANG, Seongnam-si (KR); Moongyu Lee, Suwon-si (KR); Jeehong Min, Seongnam-si (KR)

Correspondence Address: Haynes and Boone, LLP;IP Section, 2323 Victory Avenue, SUITE 700, Dallas, TX, 75219, US

(21) Appl. No.: 12/406,017

(22) Filed: Mar. 17, 2009

(30) Foreign Application Priority Data
Jun. 11, 2008 (KR) 10-2008-0054865

(51) Int. Cl. G02F 1/1335

(52) U.S. Cl. 349/114

(57) ABSTRACT

Provided are embodiments of a transreflective display panel, and a display apparatus including the transreflective display panel and a backlight unit. The transreflective display panel according to one or more embodiments includes a plurality of pixels arranged in a matrix formation, wherein each of the pixels includes a first polarizing plate, a liquid crystal layer disposed on the first polarizing plate and controlling light transmissivity of incident light according to electrical control, and a specular reflector disposed in a portion of the liquid crystal layer and reflecting external light. Thus, the display apparatus may operate in a reflective mode using the external light and a transmissive mode using the backlight unit.

### CROSS-REFERENCE TO RELATED APPLICATIONS

This application claims priority to and the benefit of Korean Patent Application No. 10-2008-0054865, filed on Jun. 11, 2008, in the Korean Intellectual Property Office, the disclosure of which is incorporated herein in its entirety by reference.

### BACKGROUND

Embodiments of the present disclosure generally relate to a transreflective display panel and a display apparatus including the same.

Various portable terminals have been developed in conjunction with advancements in communication and display devices. Examples of portable terminals include personal digital assistants (PDAs), portable multimedia players (PMPs), digital multimedia broadcasting (DMB), etc. A liquid crystal display (LCD), which does not have light emitting capabilities, is a type of light receiving flat panel display (FPD) used in such a portable terminal. Thus, the LCD controls the transmissivity of light illuminated by a light source in each pixel to form images. For this purpose, a backlight unit is installed on a back surface of the LCD so as to generate light.

One of the major advantages of portable terminals is that they can be used anywhere due to their portability characteristics. Thus, portable terminals are frequently used outdoors in sunny conditions. In this case, however, the visibility of a display may be low due to the relative darkness of a screen. Thus, the portability characteristics of portable terminals may not be fully utilized. Also, the visibility of LCDs may be low when LCDs are used in outdoor billboards or displays in electrically illuminated public places.

In order to overcome such visibility problems, displays that can operate in reflection modes and transmission modes have been developed.

### SUMMARY

Embodiments of the present disclosure provide a transreflective display panel, and a display apparatus including the transreflective display panel and a backlight unit, whereby the display apparatus operates in a reflective mode using external light and a transmissive mode using the backlight unit.

According to an embodiment of the present disclosure, there is provided a display panel comprising a plurality of pixels arranged in a matrix formation, wherein each of the pixels comprises a first polarizing plate; a liquid crystal layer disposed on the first polarizing plate and controlling light transmissivity of incident light according to electrical control; a specular reflector disposed in a portion of the liquid crystal layer and reflecting external light; a second polarizing plate disposed on the liquid crystal layer; and a diffusion plate disposed on the second polarizing plate.

The display panel may further comprise a first quarter wave plate disposed between the first polarizing plate and the liquid crystal layer; and a second quarter wave plate disposed between the liquid crystal layer and the second polarizing plate.

The diffusion plate may be adhered to the second polarizing plate so as to be combined with the second polarizing plate without a medium of an air layer therebetween.

The diffusion plate may have first haze with respect to inclined incident light, and may have second haze with respect to front incident light, wherein the second haze may be greater than the first haze.

The display panel may further comprise an anti reflection layer disposed on the diffusion plate in order to reduce reflection of the external light.

The specular reflector comprises a reflective angle controlling unit that is inclined with respect to a horizontal surface of the specular reflector.

The first polarizing plate may be a reflective type polarizing plate.

The specular reflector may be disposed in a middle portion of the liquid crystal layer along a thickness direction of the liquid crystal layer.

According to another embodiment of the present disclosure, there is provided a display apparatus comprising a display panel comprising a backlight unit emitting light; and a display panel comprising a plurality of pixels disposed on the backlight unit and arranged in a matrix formation so as to form an image, wherein each of the pixels comprises: a first polarizing plate; a liquid crystal layer disposed on the first polarizing plate and controlling light transmissivity of incident light according to electrical control; a specular reflector disposed in a portion of the liquid crystal layer and reflecting external light; a second polarizing plate disposed on the liquid crystal layer; and a diffusion plate disposed on the second polarizing plate.

### BRIEF DESCRIPTION OF THE DRAWINGS

Exemplary embodiments of the present disclosure will be more clearly understood from the following detailed description taken in conjunction with the accompanying drawings in which:

FIG. 1 is a cross-sectional view of a single pixel of a display apparatus according to an embodiment of the present disclosure;

FIG. 2A is a cross-sectional view for explaining an operation of the display apparatus of FIG. 1, for realizing white color, according to an embodiment of the present disclosure;

FIG. 2B is a cross-sectional view for explaining an operation of the display apparatus of FIG. 1, for realizing black color, according to an embodiment of the present disclosure;

FIG. 3 is a cross-sectional view of a single pixel of a display apparatus according to another embodiment of the present disclosure;

FIG. 4A is a cross-sectional view for explaining an operation of the display apparatus of FIG. 3, for realizing black color, according to an embodiment of the present disclosure;

FIG. 4B is a cross-sectional view for explaining an operation of the display apparatus of FIG. 3, for realizing white color, according to another embodiment of the present disclosure;

FIG. 5A is a cross-sectional view of a single pixel of a display apparatus according to another embodiment of the present disclosure;

FIG. 5B is an enlarged view of a reflective angle controlling unit disposed on a specular reflector of the display apparatus illustrated in FIG. 5A, according to an embodiment of the present disclosure; and

FIG. 6 is a cross-sectional view of a single pixel of a display apparatus according to another embodiment of the present disclosure.

### DETAILED DESCRIPTION

Hereinafter, embodiments of the present disclosure will be described in detail by explaining exemplary embodiments with reference to the attached drawings.

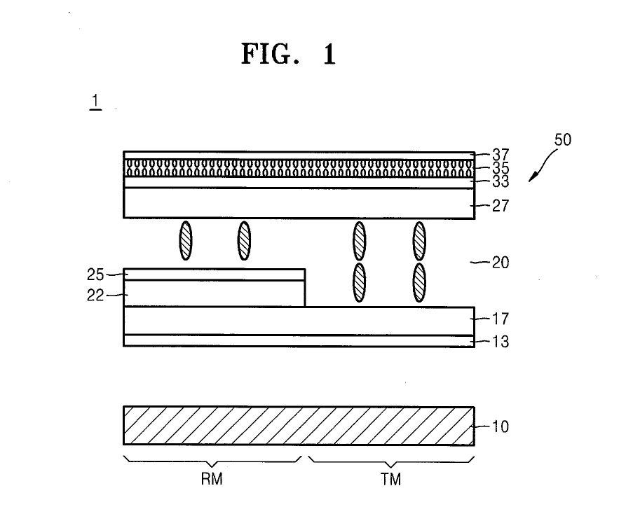

FIG. 1 is a cross-sectional view of a single pixel 1 of a display apparatus according to an embodiment of the present disclosure. A plurality of pixels is arranged in a matrix formation to constitute a display panel or a display apparatus. The display panel 50 is a transreflective display panel including a reflective region RM and a transmissive region TM. In the reflective region RM, external light is reflected to form images. In the transmissive region TM, light emitted from a backlight unit 10 is transmitted to form images.

The display apparatus according to the present embodiment includes the backlight unit 10 and a display panel 50. A liquid crystal display (LCD), which does not have light emitting capabilities, is a type of light receiving flat panel display (FPD) that may be used in a portable terminal or a general display apparatus. Thus, the LCD requires a separate light source. The LCD controls the transmissivity of light generated by a light source in each pixel to form images. Such a light source may be the backlight unit 10, which is installed on a back surface of the LCD. In the present embodiment, an image may be formed by light emitted from the backlight unit 10 or external light. The backlight unit 10 may be classified as a direct light type backlight unit or as an edge light type backlight unit according to the arrangement of the light source. In a direct light type backlight unit, a lamp installed just below a liquid crystal panel emits light directly onto the liquid crystal panel. In an edge light type backlight unit, light is emitted to the liquid crystal panel via a light guide plate. The display apparatus according to the present embodiment may include either a direct light type backlight unit or an edge light type backlight unit. The backlight unit 10 is designed so as to emit collimating light, and thus light leakage due to inclination light incident on a liquid crystal layer may be reduced.

The display panel 50 includes the backlight unit 10, a first polarizing plate 13, a liquid crystal layer 20, a second polarizing plate 33 and a diffusion plate 35. The liquid crystal layer 20 is disposed between a first transparent substrate 17 and a second transparent substrate 27. The first polarizing plate 13 may be an absorbing type polarizing plate transmitting first polarized light of incident light and absorbing second polarized light perpendicular to the first polarized light, or may be a reflective type polarizing plate transmitting the first polarized light and reflecting the second polarized light. In the present embodiment, the first polarizing plate 13 is an absorbing type polarizing plate. The second polarizing plate 33 is substantially the same as the first polarizing plate 13, and transmits the first polarized light and absorbs the second polarized light.

A specular reflector 25 is disposed in a portion of the liquid crystal layer 20. The portion where the specular reflector 25 is disposed corresponds to the reflective region RM. The remaining portion of the liquid crystal layer 20 not containing the specular reflector 25 corresponds to the transmissive region TM. Light emitted from the outside is reflected by the specular reflector 25 so as to form images. Light emitted from the backlight unit 10 is transmitted in the portion of the liquid crystal layer 20 not containing the specular reflector 25 so as to form images. The specular reflector 25 is disposed in a middle portion of the liquid crystal layer 20 along a thickness direction of the liquid crystal layer 20 in order to match optical path lengths since light proceeds through the liquid crystal layer 20 twice in a reflective mode, but light proceeds through the liquid crystal layer 20 once in a transmissive mode. The specular reflector 25 may be disposed on a plate 22. Generally, it may be difficult to install additional structures such as a diffusion reflection plate, etc. in the liquid crystal layer 20. However, owing to a simple configuration of the specular reflector 25, the specular reflector 25 may be installed in the liquid crystal layer 20 by using a simple process.

The liquid crystal layer 20 controls light transmissivity according to a voltage applied to the liquid crystal layer 20. The liquid crystal layer 20 may include twisted nematic (TN) liquid crystal, vertical alignment (VA) liquid crystal, electrically controlled birefringence (ECB) liquid crystal, etc.

In the meantime, the diffusion plate 35 is provided in order to widen the viewing angle, and is closely adhered to the second polarizing plate 33 so as to be combined with the diffusion plate 35 without a medium of an air layer therebetween. In the present embodiment, the diffusion plate 35 is closely combined with the second polarizing plate 33 so that the thickness of an interface between the diffusion plate 35 and the second polarizing plate 33 is reduced so as to reduce the amount of reflective light emitted from the outside, thereby improving visibility. In addition, the amount of transmissive light is increased so as to increase the amount of light that is reflected by the specular reflector 25 and then emitted to the outside. An anti reflection layer 37 may be further disposed on the diffusion plate 35 so that external light can be prevented from being reflected by the diffusion plate 35, thereby maintaining visibility.

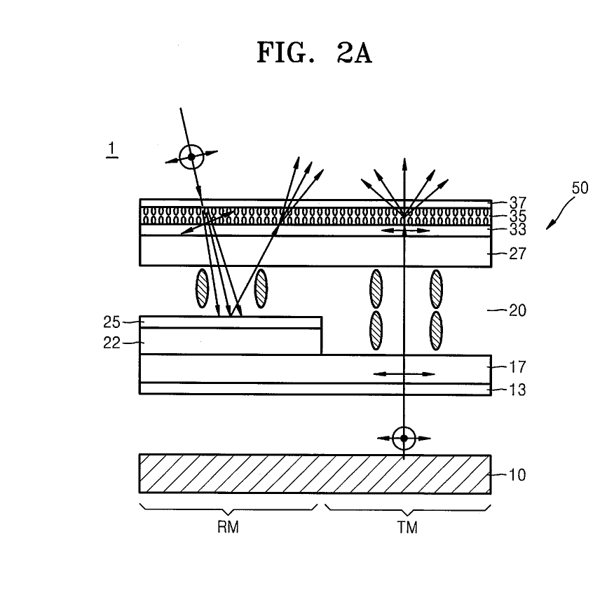

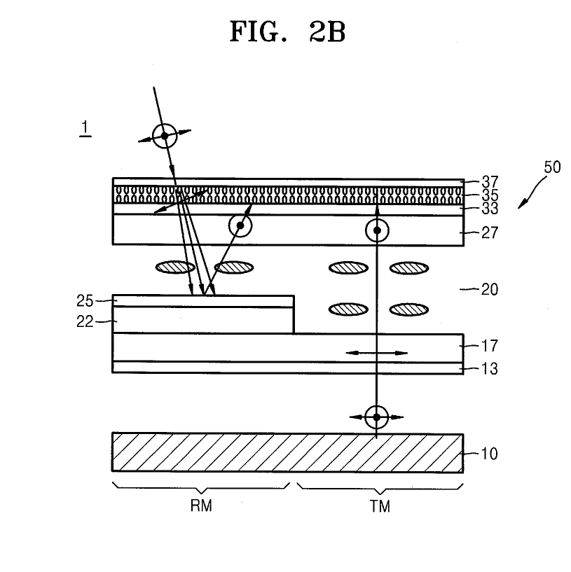

Next, an operation of the display apparatus according to the present embodiment will be described in terms of a VA liquid crystal mode in which the display apparatus operates in a normally white state. FIG. 2A is a cross-sectional view for explaining a reflective mode and a transmissive mode when a voltage is not applied to the pixel 1 (V=off), for realizing white color, according to an embodiment of the present disclosure. In the reflective mode, when unpolarized external light passes through the second polarizing plate 33, only first polarized light is transmitted. Phase delay does not occur since a voltage is not applied to the liquid crystal layer 20. Thus, the first polarized light is reflected by the specular reflector 25 while a polarization state of the first polarized light is not changed. The light reflected by the specular reflector 25 is transmitted through the second polarizing plate 33 to realize white color. Since the first polarized light is diffused through the diffusion plate 35, a sufficient viewing angle can be ensured. In addition, when the diffusion plate 35 is closely combined with the second polarizing plate 33 without a medium of an air layer therebetween, transmissivity and contrast ratio with respect to external light may be improved compared to the case where the diffusion plate 35 is separated from the second polarizing plate 33. Since external light incident on a screen at an angle of about 30 degrees with respect to the screen is used in the reflective mode, and light is transmitted through the diffusion plate 35 twice, images might partially overlap in a high resolution image. To overcome this problem, the diffusion plate 35 is designed so as to reduce haze with respect to the incident light. Haze is defined as a ratio of diffused light with respect to transmissive light. That is, the diffusion plate 35 is designed so that the incident light mainly used in the reflective mode is not largely diffused when passing through the diffusion plate 35. On the other hand, collimating light emitted from the backlight unit 10 is incident directly on the diffusion plate 35. This direct incident light is used in the transmissive mode. The diffusion plate 35 is designed so as to increase haze in order to diffuse the direct incident light through the diffusion plate 35. By manufacturing the diffusion plate 35 having different hazes according to incident angle of light, transmissive amount and viewing angle may be improved in both the reflective mode and the transmissive mode.

In terms of the transmissive mode, when non-polarized light emitted from the backlight unit 10 passes through the first polarizing plate 13, only the first polarized light is transmitted to pass through the liquid crystal layer 20. Since phase delay does not occur in the liquid crystal layer 20, light transmitted through the liquid crystal layer 20 with a first polarization state is incident on the second polarizing plate 33. The first polarized light is transmitted through the second polarizing plate 33 to be output to the outside so as to realize white color. Since the first polarized light is diffused through the diffusion plate 35, a sufficient viewing angle may be ensured. The backlight unit 10 emits collimating light, for example, light that is focused with full width at half maximum (FWHM) of brightness in the range of about ±20°. Generally, the inclination incident light leaks at the liquid crystal layer 20. However, by emitting the collimating light, leakage of the incident light is reduced, thereby improving contrast ratio in the transmissive mode.

FIG. 2B is a cross-sectional view for explaining a reflective mode and a transmissive mode when a voltage is applied to the pixel 1 (V=on), for realizing black color, according to an embodiment of the present disclosure. In the reflective mode, unpolarized external light passes through the anti reflection layer 37 and the diffusion plate 35 to be incident on the second polarizing plate 33. Only first polarized light is transmitted through the second polarizing plate 33 to be incident on the liquid crystal layer 20. Phase delay occurs by ¼ wavelength in the liquid crystal layer 20, and thus the first polarized light is converted into circularly polarized light. The circularly polarized light is reflected by the specular reflector 25. Then, phase delay of ¼ wavelength occurs in the liquid crystal layer 20, and the circularly polarized light is converted to second polarized light. The second polarized light is absorbed by the second polarizing plate 33 to realize black color. Then, in the transmissive mode, only first polarized light of non-polarized light emitted from the backlight unit 10 is transmitted through the first polarizing plate 13 to be incident on the liquid crystal layer 20. Phase delay occurs by ½ wavelength in the liquid crystal layer 20, and thus the first polarized light is converted into second polarized light perpendicular to the first polarized light. The second polarized light is absorbed by the second polarizing plate 33 to be in a black state.

According to the operations described above with respect to one or more embodiments, when a voltage is not applied to the liquid crystal layer 20, white color may be realized in the reflective and transmissive modes. In addition, when a voltage is applied to the liquid crystal layer 20, black color may be realized in the reflective and transmissive modes. By selectively or complementarily using the reflective and transmissive modes according to an external lighting environment, an image may be realized. In this specification, only white color and black color have been described according to one or more embodiments. However, since it is well known to one of ordinary skill in the art that other colors may be realized by color filters, such description will be not be provided here.

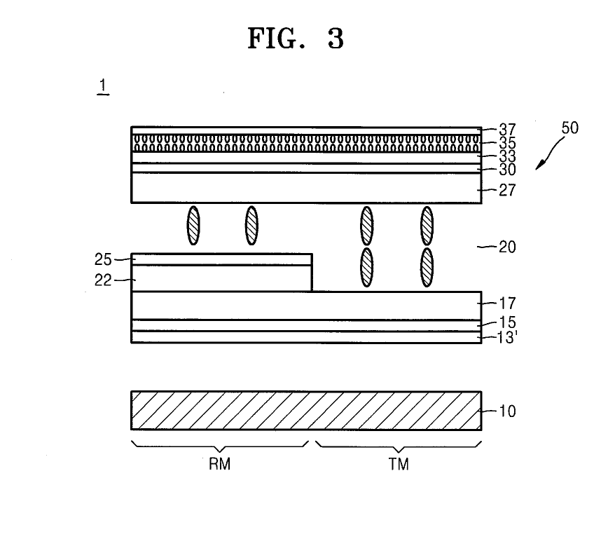

FIG. 3 is a cross-sectional view of a single pixel 1 of a display apparatus according to another embodiment of the present disclosure. In comparison with the embodiment of FIG. 1, a first quarter wave plate 15 is further disposed between a first polarizing plate 13′ and the first transparent substrate 17, and a second quarter wave plate 30 is further disposed between the second transparent substrate 27 and the second polarizing plate 33. In the embodiment of FIG. 1, the first polarizing plate 13 transmits the first polarized light and absorbs the second polarized light. On the other hand, in the embodiment of FIG. 3, the first polarizing plate 13′ absorbs the first polarized light and transmits the second polarized light.

Generally, a contrast ratio that is the important characteristic of a display apparatus is largely dependent on the amount of leakage light in a black state. In this regard, a normally black mode is advantageous to improve contrast ratio. In the normally black mode, black color is realized without phase difference in a liquid crystal when a voltage is not applied to the liquid crystal.

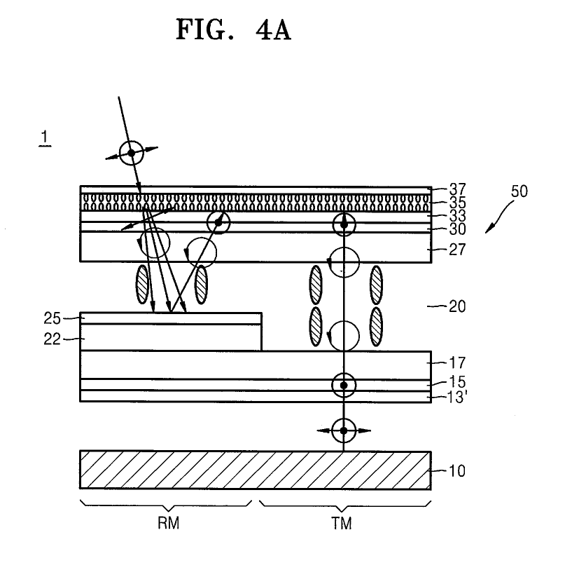

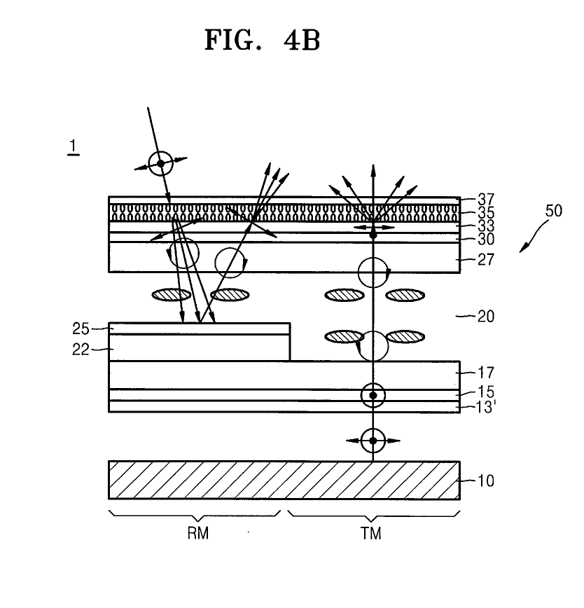

Next, an operation of the display apparatus according to the present embodiment will be described in terms of a VA liquid crystal mode in which the display apparatus operates in a normally black state. FIG. 4A is a cross-sectional view for explaining a reflective mode and a transmissive mode when a voltage is not applied to the pixel 1 (V=off), for realizing black color, according to an embodiment of the present disclosure. In the reflective mode, when unpolarized external light passes through the second polarizing plate 33, only first polarized light is transmitted, and then is converted into circularly polarized light by the second quarter wave plate 30. Since a voltage is not applied to the liquid crystal layer 20, phase delay does not occur in the liquid crystal layer 20. Thus, after the first polarized light in the form of the circularly polarized light is transmitted through the liquid crystal layer 20, the first polarized light is reflected by the specular reflector 25. When the first polarized light reflected by the specular reflector 25 passes through the second quarter wave plate 30, the first polarized light is converted into the second polarized light to be incident on the second polarizing plate 33. The second polarized light is absorbed in the second polarizing plate 33 to be in a black state. In the transmissive mode, when unpolarized light emitted from the backlight unit 10 passes through the first polarizing plate 13′, only the second polarized light is transmitted to be incident on the first quarter wave plate 15. The second polarized light is converted into circularly polarized light by the first quarter wave plate 15 to pass through the liquid crystal layer 20. Since phase delay does not occur in the liquid crystal layer 20, when light in the form of the circularly polarized light transmitted through the liquid crystal layer 20 passes through the second quarter wave plate 30, the light is converted into the second polarized light to be incident on the second polarizing plate 33. The second polarized light is absorbed by the second polarizing plate 33 to be in a black state.

FIG. 4B is a cross-sectional view for explaining a reflective mode and a transmissive mode when a voltage is applied to the pixel 1 (V=on), for realizing white color, according to an embodiment of the present disclosure. In the reflective mode, non-polarized light passes through the anti reflection layer 37 and the diffusion plate 35 to be incident on the second polarizing plate 33. Only first polarized light is transmitted through the second polarizing plate 33 to be incident on the second quarter wave plate 30. The first polarized light is converted into circularly polarized light by the second quarter wave plate 30. Phase delay occurs by ¼ wavelength in the liquid crystal layer 20, and thus the first polarized light in the form of the circularly polarized light is converted into second polarized light. Then, the second polarized light is reflected by the specular reflector 25, is converted into circularly polarized light by the liquid crystal layer 20, and then is converted back into the first polarized light by the second quarter wave plate 30. The first polarized light is transmitted through the second polarizing plate 33 to realize white color. Since the first polarized light is diffused through the diffusion plate 35, a sufficient viewing angle may be ensured. In the transmissive mode, only second polarized light of non-polarized light emitted from the backlight unit 10 is transmitted through the first polarizing plate 13′, and the second polarized light is converted into first circularly polarized light through the first quarter wave plate 15 to be incident on the liquid crystal layer 20. Phase delay by ½ wavelength occurs in the liquid crystal layer 20, and thus the first circularly polarized light is converted into second circularly polarized light perpendicular to the first circularly polarized light to be incident on the second quarter wave plate 30. In addition, the second circularly polarized light is converted into the first polarized light by the second quarter wave plate 30, and then is output to the outside through the second polarizing plate 33 and the diffusion plate 35 so as to realize white color.

According to the operations described above with respect to one or more embodiments, in both cases where a voltage is applied or not applied to the liquid crystal layer 20, white and black colors may be equally realized in the reflective and transmissive modes. In addition, by selectively or complementarily using the reflective and transmissive modes according to an external lighting environment, an image may be realized.

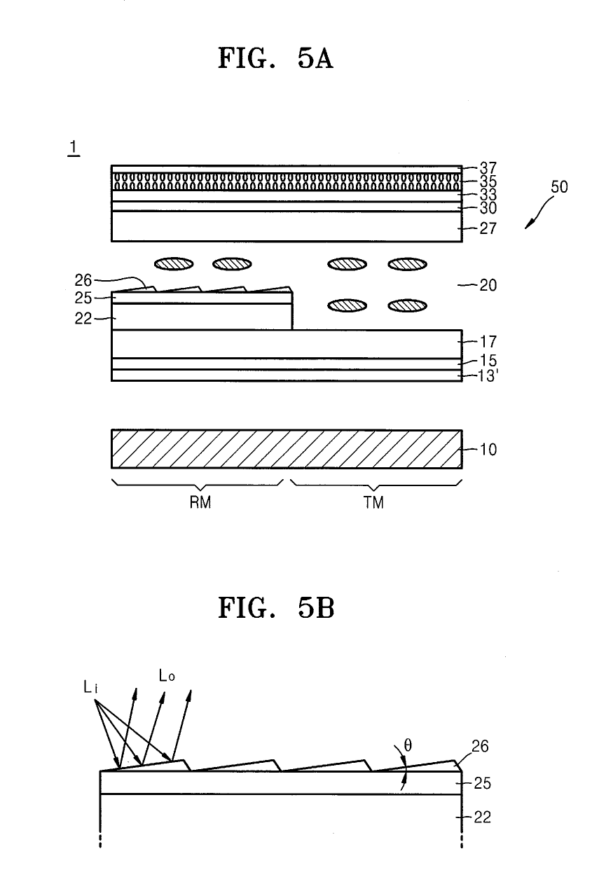

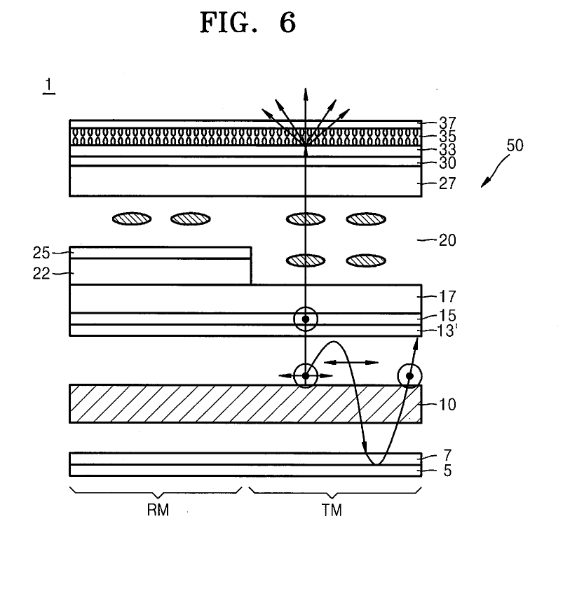

FIG. 5A is a cross sectional view of a single pixel 1 of a display apparatus in which a reflective angle controlling unit 26 is disposed on a specular reflector 25, according to another embodiment of the present disclosure. FIG. 5B is an enlarged view of the reflective angle controlling unit 26, according to an embodiment of the present disclosure. Referring to FIG. 5B, the reflective angle controlling unit 26 has a series of inclined portions inclined by a predetermined angle θ with respect to a horizontal surface of the specular reflector 25. The predetermined angle θ may be equal to or less than about 5 degrees. When the display apparatus operates in a reflective mode, light incident on the display apparatus at an angle of about 30 degrees may be generally used in the display apparatus. The reflective angle controlling unit 26 allows the light incident on the display apparatus at an angle of about 30 degrees to be output towards the front of a viewer when the light incident on the display apparatus is reflected by the specular reflector 25. Thus, high brightness may be achieved. The reflective angle controlling unit 26 controls reflective light so that incident light Lᵢ having an incident angle that is normally used in a reflective mode is reflected towards the front of a viewer. A reflective direction of output light Lₒ may be controlled according to the inclined angle θ of the reflective angle controlling unit 26.

FIG. 6 is a cross-sectional view of a single pixel 1 of a display apparatus according to another embodiment of the present disclosure. In FIG. 6, the first polarizing plate 13′ is a reflective type polarizing plate in order to improve light usage efficiency of light emitted from the backlight unit 10. A polarization conversion layer 7 and a reflective plate 5 are disposed below the backlight unit 10. The polarization conversion layer 7 converts first polarized light into second polarized light, and second polarized light into first polarized light. In FIG. 6, the case of a reflective mode is substantially the same as the case described above with reference to the embodiment of FIG. 3, and thus a description thereof will not be repeated. When the first polarizing plate 13′ is a reflective type polarizing plate, the first polarizing plate 13′ reflects the first polarized light and transmits the second polarized light. In a transmissive mode, non-polarized light emitted from the backlight unit 10 is incident on the first polarizing plate 13′, the second polarized light is transmitted, and the first polarized light is transmitted back to the backlight unit 10. When a voltage is applied to the liquid crystal layer 20, the second polarized light transmitted through the first polarizing plate 13′ passes through the liquid crystal layer 20, the second quarter wave plate 30 and the second polarizing plate 33, and then is output to the outside so as to realize white color. When a voltage is not applied to the liquid crystal layer 20, the second polarized light transmitted through the first polarizing plate 13′ passes through the liquid crystal layer 20 and the second quarter wave plate 30, and then is absorbed by the second polarizing plate 33 so as to realize black color.

In the meantime, the first polarized light, which is reflected by the first polarizing plate 13′ and then transmitted through the backlight unit 10, is transmitted through the polarization conversion layer 7, and then is reflected by the reflective plate 5. Then, while the first polarized light is transmitted through the polarization conversion layer 7, the first polarized light is converted into the second polarized light. Next, the first polarized light passes through the backlight unit 10 to be incident on the first polarizing plate 13′. In addition, the second polarized light is transmitted through the first polarizing plate 13′ to be used as available light. Likewise, by embodying the first polarizing plate 13′ as a reflective type polarizing plate, light reflected by the first polarizing plate 13′ may be reused, thereby increasing light usage efficiency. In addition, brightness may be improved and power consumption may be reduced in the transmissive mode.

While the present disclosure has been particularly shown and described with reference to exemplary embodiments thereof, it will be understood that various changes in form and details may be made therein without departing from the spirit and scope of the following claims.

What is claimed is:

1. A display panel comprising a plurality of pixels arranged in a matrix formation, wherein each of the pixels comprises:
a first polarizing plate;
a liquid crystal layer disposed on the first polarizing plate and controlling light transmissivity of incident light according to electrical control;
a specular reflector disposed in a portion of the liquid crystal layer and reflecting external light;
a second polarizing plate disposed on the liquid crystal layer; and
a diffusion plate disposed on the second polarizing plate.

2. The display panel of claim 1, further comprising:
a first quarter wave plate disposed between the first polarizing plate and the liquid crystal layer; and
a second quarter wave plate disposed between the liquid crystal layer and the second polarizing plate.

3. The display panel of claim 1, wherein the diffusion plate is adhered to the second polarizing plate so as to be combined with the second polarizing plate without a medium of an air layer therebetween.

4. The display panel of claim 1, wherein the diffusion plate has first haze with respect to inclined incident light, and has second haze with respect to front incident light, wherein the second haze is greater than the first haze.

5. The display panel of claim 1, further comprising an anti reflection layer disposed on the diffusion plate in order to reduce reflection of the external light.

6. The display panel of claim 1, wherein the specular reflector comprises a reflective angle controlling unit that is inclined with respect to a horizontal surface of the specular reflector.

7. The display panel of claim 1, wherein the first polarizing plate is a reflective type polarizing plate.

8. The display panel of claim 1, wherein the specular reflector is disposed in a middle portion of the liquid crystal layer along a thickness direction of the liquid crystal layer.

9. A display apparatus comprising a backlight unit emitting light; and a display panel comprising a plurality of pixels disposed on the backlight unit and arranged in a matrix formation so as to form an image,
wherein each of the pixels comprises:
a first polarizing plate;
a liquid crystal layer disposed on the first polarizing plate and controlling light transmissivity of incident light according to electrical control;
a specular reflector disposed in a portion of the liquid crystal layer and reflecting external light;
a second polarizing plate disposed on the liquid crystal layer; and
a diffusion plate disposed on the second polarizing plate.

10. The display apparatus of claim 9, further comprising:
a first quarter wave plate disposed between the first polarizing plate and the liquid crystal layer; and
a second quarter wave plate disposed between the liquid crystal layer and the second polarizing plate.

11. The display apparatus of claim 9, wherein the diffusion plate is adhered to the second polarizing plate so as be combined with the second polarizing plate without a medium of an air layer therebetween.

12. The display apparatus of claim 9, wherein the diffusion plate has first haze with respect to inclined incident light, and has second haze with respect to front incident light, wherein the second haze is greater than the first haze.

13. The display apparatus of claim 9, further comprising an anti reflection layer disposed on the diffusion plate in order to reduce reflection of the external light.

14. The display apparatus of claim 9, wherein the specular reflector comprises a reflective angle controlling unit that is inclined with respect to a horizontal surface of the specular reflector.

15. The display panel of claim 9, wherein the first polarizing plate is a reflective type polarizing plate.

16. The display panel of claim 15, further comprising a polarization conversion layer and a reflective plate that are disposed below the backlight unit.

17. The display panel of claim 9, wherein the specular reflector is disposed in an intermediated place of the liquid crystal layer along a thickness direction of the liquid crystal layer.

18. The display panel of claim 9, wherein the backlight unit emits light focused with full width at half maximum (FWHM) of brightness in the range of about ±20°.
